(19) United States
(12) Patent Application Publication
(10) Pub. No.: US 2005/0195283 A1
(43) Pub. Date: Sep. 8, 2005

(54) Image storing device, image storing method and automatic storing system

(75) Inventors: Kenji Sakuda, Nagano (JP); Hideki Morozumi, Nagano (JP); Yoshinao Kitahara, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/048,904

(22) Filed: Feb. 3, 2005

(30) Foreign Application Priority Data
Feb. 4, 2004 (JP) P2004-028195

(51) Int. Cl. H04N 5/225

(52) U.S. Cl. 348/207.99; 348/231.2

(57) ABSTRACT

An object of the present invention is that no user performs a complicated operation for storage and synthesis every time an image data file of an image supply device is stored to an image storing device. An acquisition means (65) of the image storing device (2) immediately obtains the image data file from the image supply device (1) through a communication means (44) after it is possible to communicate with the image supply device (1) for transmitting the image data file. A dynamic image generating means (67) generates the image data file of a dynamic image from the image data file of plural static images using continuous photographing and included within the obtained image data file. A memory means (46) stores the generated image data file of the dynamic image.

### BACKGROUND OF THE INVENTION

The present invention relates to an image storing device, an image storing method and an automatic storing system for storing an image data file stored to an image supply device to the image storing device.

Patent literature 1 (JP-A-2003-259274) discloses a printing system in which a digital camera of a USB storage class device and a printer of a USB host are directly connected by a USB (Universal Serial Bus). In the printing system of this patent literature 1, the camera generates a printer status request, a printing request, a print stopping request, etc. with respect to the printer in a file mode in accordance with the operation of its button, and writes these requests to a memory within the camera. Further, after communication connection with the camera is established, the printer periodically checks the memory within the camera at a high speed rate. When the printer finds the required file, the printer reads this file and executes a required operation.

As mentioned above, in the conventional printing system disclosed in the patent literature 1, the file of an image stored to the camera is transmitted to the printer by operating the button of the camera, and this image is printed.

It is considered that the image data file stored to the camera is transmitted and stored to the image storing device by applying this conventional printing system.

However, when a system for storing the image data file stored to the camera to the image storing device by applying such a conventional printing system is considered, a user operates the button of the camera and generates the status request, the storing request, etc. with respect to the image storing device and must make the image storing device obtain these requests.

Accordingly, for example, after the camera and the image storing device are physically connected, no file of the image stored to the camera can be stored to the image storing device by merely applying such a conventional printing system unless the user performs an obtaining operation of software, a setting operation of a storing condition, etc.

Further, it cannot be said that a series of these operations required to transmit the file of the image from the camera to the image storing device is simple. Furthermore, these operations are repeatedly required every time the file of the image is intended to be transmitted. Therefore, some users feel that the series of these operations required to transmit the file of the image is complicated.

In particular, when the image picked up in a continuous photographing mode and a panoramic mode is stored to the camera, it is necessary for the user to make a work for synthesizing the image in addition to the series of these storing operations. Therefore, the user might feel that this work is further complicated.

### SUMMARY OF THE INVENTION

An object of the present invention is to provide an image storing device, an image storing method and an automatic storing system in which no user performs a complicated operation for storage and synthesis every time the image data file of the image supply device is stored to the image storing device.

In the present invention, the following constructions are used to solve the problems.

An image storing device in the present invention comprises communication means; acquisition means for immediately obtaining an image data file from an image supply device through the communication means after it is possible to communicate with the image supply device for transmitting the image data file; dynamic image generating means for generating the image data file of a dynamic image from the image data file of plural static images using continuous photographing and included within the obtained image data file; and memory means for storing the generated image data file of the dynamic image.

If this construction is adopted, even when an image data file requiring image synthesis is included in the image data file from the image supply device, these image data files are automatically stored as image data files after this synthesis. Therefore, it is not necessary for a user to perform a complicated operation for storage and synthesis every time the image data file of the image supply device is stored to the image storing device.

Another image storing device in the present invention comprises communication means; acquisition means for immediately obtaining an image data file from an image supply device through the communication means after it is possible to communicate with the image supply device for transmitting the image data file; panoramic generating means for generating the image data file of a panoramic image by synthesizing plural image data files including images each constituting one portion of the panoramic image among the obtained image data file; and memory means for storing the generated image data file of the panoramic image.

If this construction is adopted, even when plural image data files each including one portion of the panoramic image exist in the image data file from the image supply device, these image data files are automatically stored as image data files of the panoramic image after this synthesis. Therefore, it is not necessary for a user to perform a complicated operation for storage and synthesis every time the image data file of the image supply device is stored to the image storing device.

An image storing method in the present invention comprises a step for immediately transmitting an image data file from an image supply device to an image storing device after the image supply device for transmitting the image data file and the image storing device for storing the image data file can be communicated; a step for generating the image data file of a dynamic image from the image data file of plural static images using continuous photographing and included within the image data file by the image storing device; and a step for storing the generated image data file of the dynamic image to memory means of the image storing device.

If this construction is adopted, even when an image data file requiring image synthesis is included in the image data file from the image supply device, these image data files are automatically stored as image data files after this synthesis. Therefore, it is not necessary for a user to perform a complicated operation for storage and synthesis every time the image data file of the image supply device is stored to the image storing device.

Another image storing method in the present invention comprises a step for immediately transmitting an image data file from an image supply device to an image storing device after the image supply device for transmitting the image data file and the image storing device for storing the image data file can be communicated; a step for generating the image data file of a panoramic image by synthesizing plural image data files including images each constituting one portion of the panoramic image among the image data files by the image storing device; and a step for storing the generated image data file of the panoramic image to memory means of the image storing device.

If this construction is adopted, even when plural image data files each including one portion of the panoramic image exist in the image data file from the image supply device, these image data files are automatically stored as image data files of the panoramic image after this synthesis. Therefore, it is not necessary for a user to perform a complicated operation for storage and synthesis every time the image data file of the image supply device is stored to the image storing device.

An automatic storing system in the present invention comprises the image storing device in accordance with one of the above inventions; and the image supply device which has another communication means connected to the communication means of the image storing device and immediately starts storage processing of the image data file to the image storing device when this another communication means can communicate with the image storing device.

If this construction is adopted, when an image data file requiring image synthesis is included in the image data file from the image supply device, these image data files are automatically stored as image data files after this synthesis. Otherwise, if this construction is adopted, when plural image data files each including one portion of the panoramic image exist in the image data file from the image supply device, these image data files are automatically stored as image data files of the panoramic image after this synthesis. Therefore, it is not necessary for a user to perform a complicated operation for storage and synthesis every time the image data file of the image supply device is stored to the image storing device.

In the present invention, no user performs the complicated operation for storage and synthesis every time the image data file of the image supply device is stored to the image storing device.

The present disclosure relates to the subject matter contained in Japanese patent application No. 2004-028195 filed on Feb. 4, 2005, which is expressly incorporated herein by reference in its entirety.

### BRIEF DESCRIPTION OF THE DRAWINGS

FIG. 1 is a constructional view showing an automatic storing system in accordance with an embodiment mode of the present invention.

FIG. 2 is a block diagram showing the hardware construction of DSC within FIG. 1.

FIG. 3 is a view showing the stored contents of a flash memory within FIG. 2.

FIG. 4 is a view showing the stored contents of a removable memory within FIG. 2.

FIG. 5 is a block diagram showing the hardware construction of a wireless server within FIG. 1.

FIG. 6 is a view showing the stored contents of a memory within FIG. 5.

FIG. 7 is a view showing the stack structure of a communication protocol for automatic storage realized in the automatic storing system of FIG. 1.

FIG. 8 is a view showing an automatic storage processing sequence executed between DSC within FIG. 1 and the wireless server.

FIG. 9 is a view showing one example of a store request generated by a copy client.

FIG. 10 is a flow chart showing one example of storage processing of a storage processing section.

### DESCRIPTION OF THE PREFERRED EMBODIMENT

An image storing device, an image storing method and an automatic storing system in accordance with an embodiment mode of the present invention will next be explained on the basis of the drawings. The image storing device will be explained with a wireless server as an example. The image storing method will be explained as one portion of the operation of the wireless server.

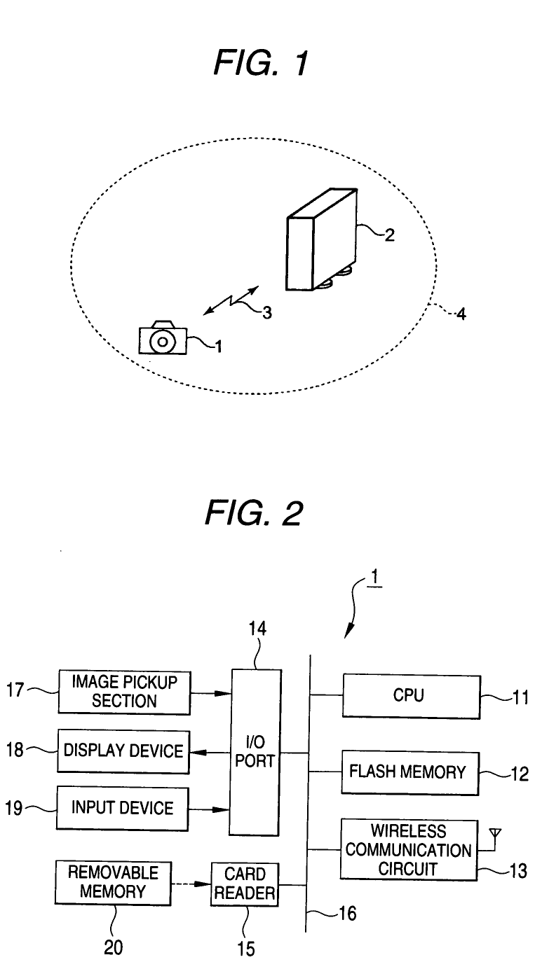

FIG. 1 is a constructional view showing the automatic storing system in accordance with the embodiment mode of the present invention. The automatic storing system has a digital still camera (DSC) 1 as an image supply device for transmitting an image data file, and a wireless server 2 as the image storing device. DSC 1 and the wireless server 2 are connected by a wireless network 3 using wireless communication.

In the wireless network 3, for example, there are a wireless network 3 based on IEEE (the Institute of Electrical and Electronic Engineers) 802.11, a near distance wireless communication network such as Bruetooth (registered trademark), etc. In the wireless network 3, an infrared ray, etc. may be also used instead of usage of a radio wave as in these networks. Further, the wireless network 3 may also have an access limit function using advance registration of a MAC (Media Access Control) address, etc., a wiretap preventing function using WEP (Wired Equivalent Privacy), etc.

This wireless network 3 is realized by locating DSC 1 within a wireless connecting range 4 of the wireless server 2. It may be also said in other words that the wireless server 2 exists within the wireless connecting range of DSC 1. Namely, the communication between DSC 1 and the wireless server 2 can be performed by locating DSC 1 within the wireless connecting range 4 of the wireless server 2 or locating the wireless server 2 within the wireless connecting range of DSC 1.

FIG. 2 is a block diagram showing the hardware construction of DSC 1 within FIG. 1. DSC 1 has a central processing unit (CPU) 11 for executing a program, a flash memory 12, a wireless communication circuit 13 as a communication means connected to the wireless network 3, an I/O (Input/Output) port 14, a card reader 15, and a bus 16 for connecting these members. An image pickup section 17 for generating image data by picking-up an image, a display device 18 for displaying various kinds of data and the image, and an input device 19 for generating input data according to an operation are connected to the I/O port 14. A removable memory 20 using a semiconductor memory, etc. is inserted into the card reader 15 so as to be inserted and pulled out.

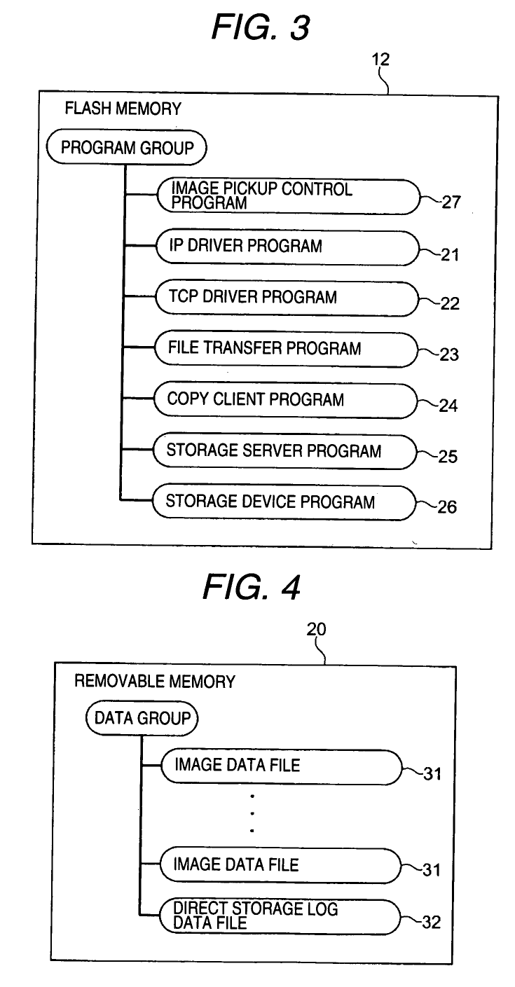

FIG. 3 is a view showing stored contents of the flash memory 12 within FIG. 2. A program group is stored to the flash memory 12. The program group of the flash memory 12 includes an IP (Internet Protocol) driver program 21, a TCP (Transmission Control Protocol) driver program 22, a file transfer program 23, a copy client program 24, a storage server program 25, a storage device program 26 and an image pickup control program 27.

The image pickup control program 27 realizes an image pickup section by executing this image pickup control program 27 by the central processing unit 11. The image pickup control section controls the operation of the image pickup section 17. The image pickup control section stores the image data picked up by this image pickup section 17 to the removable memory 20 as an image data file of a format such as JPEG (Joint Photographic Expert Group), EXIF (Exchangeable Image File Format), etc.

The IP driver program 21 realizes an IP driver by executing this IP driver program 21 by the central processing unit 11. An IP address is used in the Internet protocol. The IP address is an address properly allocated every communication device within at least the wireless network 3. The IP driver transmits and receives communication data between this IP driver and another IP driver by using the IP address.

The TCP driver program 22 realizes a TCP driver by executing this TCP driver program 22 by the central processing unit 11. The TCP driver secures connection between this TCP driver and another TCP driver, and manages a communication path.

The file transfer program 23 realizes a file transfer section by executing this file transfer program 23 by the central processing unit 11. The file transfer section transmits and receives a file between this file transfer section and another file transfer section.

The copy client program 24 realizes a copy client by executing this copy client program 24 by the central processing unit 11. The copy client transmits and receives a request and a response relating to advance control of storage processing and the storage processing.

The storage server program 25 realizes a storage server by executing this storage server program 25 by the central processing unit 11. The storage server transmits and receives a request and a response relating to storage.

The storage device program 26 realizes a storage device by executing this storage device program 26 by the central processing unit 11. For example, the storage device performs input-output processing with respect to storage of the removable memory 20, etc.

FIG. 4 is a view showing stored contents of the removable memory 20 within FIG. 2. A data group is stored to the removable memory 20. An image data file 31 is included in the data group of the removable memory 20. Image data of one static image are stored to the image data file 31. The image data generated by the image pickup section 17 are included in the image data file 31 of this removable memory 20. The image data file 31 also has file names and file IDs (addresses) different from each other.

A direct storage log data file 32 is also included in the data group of the removable memory 20. The direct storage log data file 32 is a file for recording a log (storage hysteresis) of direct storage relating to the image data file 31 stored to this removable memory 20. Concretely, file information (file name, file ID, etc.) of the image data file 31 automatically stored in a certain case is stored to the direct storage log data file 32. The direct storage log data file 32 may be also stored to the flash memory 12 of DSC 1. A generating time of the file, EXIF data of this file, image data or a hash value of its file (entire data), etc. may be also stored to the direct storage log data file 32 as the file information.

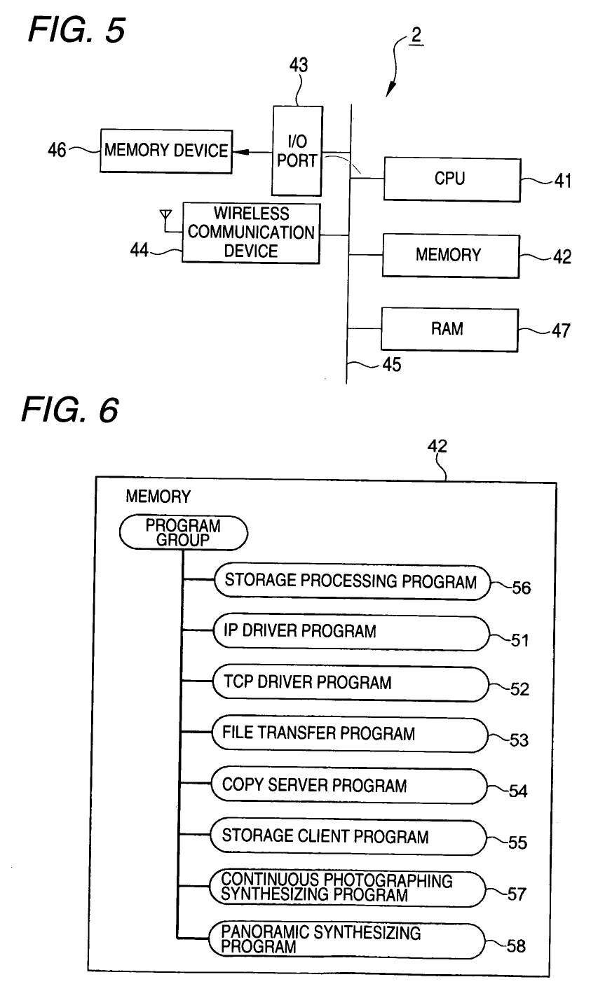

FIG. 5 is a block diagram showing the hardware construction of the wireless server 2 within FIG. 1. The wireless server 2 has a central processing unit 41, a memory 42 storing a program in advance, an I/O port 43, a wireless communication circuit 44 as a communication means connected to the wireless network 3, a bus 45 for connecting these members, and a RAM (Random Access Memory) 47 for temporary storage. A memory device 46 as a memory means is connected to the I/O port 43. For example, the memory device 46 is a nonvolatile recording medium such as a hard disk device, an optical disk device, etc., and can store a large amount of data in comparison with the removable memory 20 of DSC 1. Differing from the case of temporary storage to the RAM 47, the image data file is stored to the memory device 46 for the purpose of holding.

FIG. 6 is a view showing stored contents of the memory 42 within FIG. 5. A program group is stored to the memory 42. The program group of the memory 42 includes a storage processing program 56, an IP driver program 51, a TCP driver program 52, a file transfer program 53, a copy server program 54, a storage client program 55, a continuous photographing synthesizing program 57 and a panoramic synthesizing program 58.

The storage processing program 56 realizes a storage processing section as a judging means and a storage processing means by executing this storage processing program 56 by the central processing unit 41. The storage processing section stores a file obtained from DSC 1 and stored to the RAM 47 to the memory device 46.

The continuous photographing synthesizing program 57 realizes a continuous photographing synthesizing section as a dynamic image generating means by executing this continuous photographing synthesizing program 57 by the central processing unit 41. The continuous photographing synthesizing section generates the image data file of one dynamic image from the image data file of plural static images picked up in the continuous photographing mode. For example, there is a dynamic image of an animation GIF (Graphics Interchange Format) format as the dynamic image made by synthesizing the plural static images.

The panoramic synthesizing program 58 realizes a panoramic synthesizing section as a panoramic generating means by executing this panoramic synthesizing program 58 by the central processing unit 41. The panoramic synthesizing section generates the image data file of one static image from the image data file of plural static images picked up in the panoramic mode.

The IP driver program 51 realizes an IP driver by executing this IP driver program 51 by the central processing unit 41. The TCP driver program 52 realizes a TCP driver by executing this TCP driver program 52 by the central processing unit 41. The file transfer program 53 realizes a file transfer section by executing this file transfer program 53 by the central processing unit 41.

The copy server program 54 realizes a copy server by executing this copy server program 54 by the central processing unit 41. The copy server transmits and receives a request and a response relating to advance control of storage processing and the storage processing between this copy server and a copy client.

The storage client program 55 realizes a storage client as an acquisition means by executing this storage client program 55 by the central processing unit 41. The storage client transmits and receives a request and a response relating to storage between this storage client and a storage server.

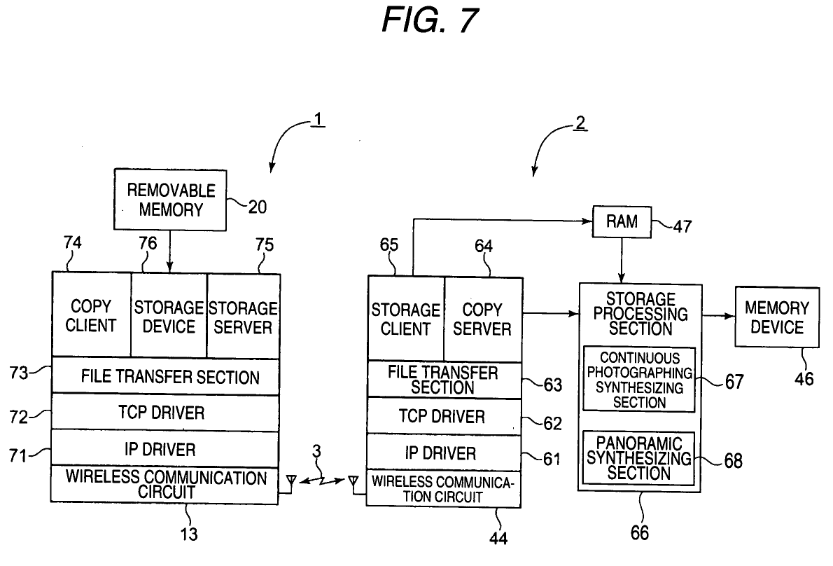

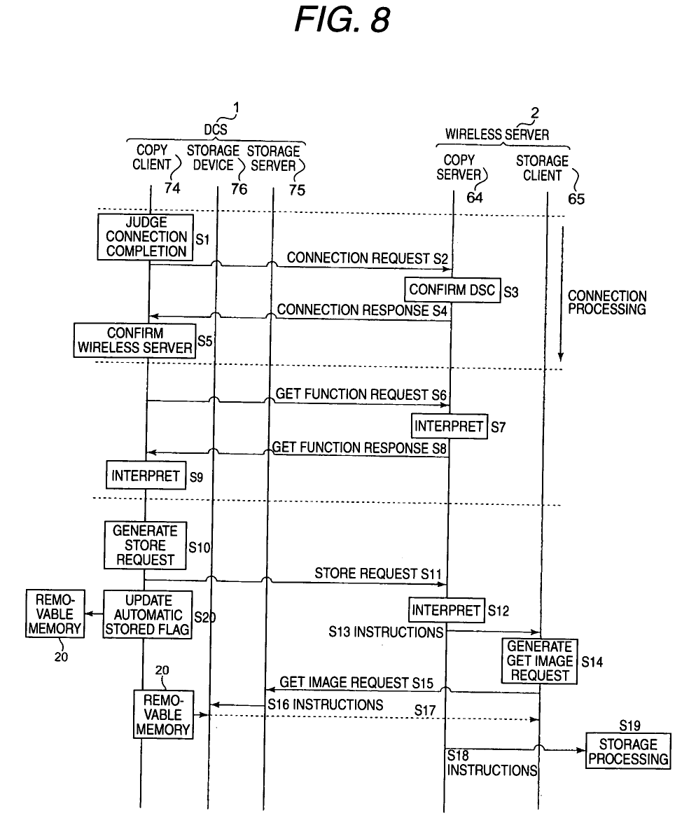

The operation of the automatic storing system having the above construction will next be explained. FIG. 7 is a view showing the stack structure of a communication protocol for automatic storage realized by the automatic storing system of FIG. 1. FIG. 8 is a view showing an automatic storage processing sequence executed between DSC 1 within FIG. 1 and the wireless server 2

In the wireless server 2, various programs are executed at a starting time and an IP driver 61, a TCP driver 62 and a file transfer section 63 exist in the high order of the wireless communication circuit 44. A copy server 64 and a storage client 65 exist in the high order of this file transfer section 63. Further, a storage processing section 66, a continuous photographing synthesizing section 67 and a panoramic synthesizing section 68 are realized in the wireless server 2.

No DHCP (Dynamic Host Configuration Protocol) server for executing allocation of the IP address exists in this wireless network 3. Accordingly, even when the IP driver 61 of the wireless server 2 transmits an additional request of the IP address to the wireless network 3, no IP driver 61 can obtain the self IP address as its response.

Therefore, acquisition waiting of the IP address with respect to this DHCP server becomes time out. When this time out is generated, the IP driver 61 of the wireless server 2 selects one IP address from plural IP addresses allocated in advance. Next, the IP driver 61 of the wireless server 2 makes the wireless communication circuit 44 transmit request data for confirming whether this IP address is used or not. In this request data, a broadcast address is designated as its transmission destination.

For example, when the wireless server 2 is started prior to DSC 1, no wireless communication circuit 44 of the wireless server 2 receives response data even when a predetermined time has passed from the transmission of this request data. After this time out, the IP driver 61 of the wireless server 2 designates the selected IP address to the self IP address. Thus, the wireless server 2 is started. Thereafter, the wireless server 2 periodically tries the detection of a separate connectable device (DSC 1).

On the other hand, when DSC 1 is started and various programs are executed, an IP driver 71, a TCP driver 72 and a file transfer section 73 are realized in the high order of the wireless communication circuit 13 in DSC 1. Further, a copy client 74, a storage server 75 and a storage device 76 are realized in the high order of this file transfer section 73.

When a power source of DSC 1 is turned on, DSC 1 starts acquisition processing of the IP address. However, the acquisition waiting of the IP address with respect to the DHCP server also becomes time out with respect to this DSC 1. Accordingly, the IP driver 71 of DSC 1 selects one IP address from plural IP addresses allocated in advance, and makes the wireless communication circuit 13 transmit request data for confirming whether this selected IP address is used or not.

When DSC 1 exists within the wireless connecting range 4 of the wireless server 2, the request data sent to this wireless network 3 are received by the wireless communication circuit 44 of the wireless server 2. The wireless communication circuit 44 of the wireless server 2 outputs these request data to the IP driver 61 of the wireless server 2. The IP driver 61 of the wireless server 2 compares the self IP address and the IP address included in the request data. When these IP addresses conform to each other, the IP driver 61 makes the wireless communication circuit 44 transmit the response data. The response data sent to the wireless network 3 are received by the wireless communication circuit 13 of DSC 1.

When the wireless communication circuit 13 of DSC 1 receives these response data, the wireless communication circuit 13 outputs these response data to the IP driver 71 of DSC 1. When time out is performed without receiving the response data by the IP driver 71 of DSC 1, the IP driver 71 designates the selected IP address to the self IP address.

On the other hand, when the IP driver 71 receives the response data, the IP driver 71 again selects a separate IP address from the plural IP addresses allocated in advance and makes the wireless communication circuit 13 transmit request data for confirming whether this newly selected IP address is used or not.

Thereafter, the IP driver 71 of DSC 1 repeats the reselection processing and the confirmation processing of the IP address until an unused IP address is found. No IP addresses are overlapped with each other within the wireless network 3 by the above control even when the wireless server 2 and DSC 1 separately perform the selection processing of the IP address. There is a possibility that no DSC 1 exists within the wireless connecting range 4 of the wireless server 2 at the starting time and the same IP address is allocated to DSC 1 and the wireless server 2 when DSC 1 is thereafter moved into the wireless connecting range 4 of the wireless server 2. However, when the IP addresses of both DSC 1 and the wireless server 2 are the same, one of the IP addresses is changed at a connection processing time of DSC 1 and the wireless server 2 or the moving time to the wireless connecting range 4.

Thus, the IP addresses of DSC 1 and the wireless server 2 are determined. When the IP addresses are determined, the file transfer section 73 of DSC 1 searches a connectable separate device. When no connectable separate device is detected, the file transfer section 73 of DSC 1 thereafter periodically or continuously searches such a device. In this case, the file transfer section 73 of DSC 1 broadcasts a predetermined request within the network, and detects the connectable separate device on the basis of its response. Accordingly, when DSC 1 exists within the wireless connecting range 4 of the wireless server 2, the file transfer section 63 of the wireless server 2 transmits the response to this request. Thus, DSC 1 detects the existence of the wireless server 2 and the wireless server 2 detects the existence of DSC 1. The communication based on TCP/IP between DSC 1 and the wireless server 2 can be then performed.

When the copy client 74 of DSC 1 detects the existence of the wireless server 2, the copy client 74 can perform the communication based on the TCP/IP. Therefore, the copy client 74 judges that the connection processing to the wireless server 2 is completed (step S1), and immediately (i.e., automatically) starts the automatic storage processing without waiting for the operation of a user, etc.

The copy client 74 of DSC 1 may also judge that the connection processing with the wireless server 2 is completed on the basis of e.g., connection establishment using the TCP in addition to the judgment based on the determination of the IP address.

When the connection processing with the wireless server 2 is completed, the copy client 74 of DSC 1 and/or the copy server 64 of the wireless server 2 performs the connection processing as first processing of the automatic storage processing. Concretely, for example, the copy client 74 of DSC 1 transmits a connection request to judge whether or not the wireless server 2 can execute the automatic storage of the same system as DSC 1 (step S2). This connection request is a request described in the XML (eXtensible Markup Language) format and is treated as one text data file. Hereinafter, requests and responses transmitted and received between the copy client 74 and the copy server 64 and between the storage client 65 and the storage server 75 are similarly described by the XML.

The connection request generated in the copy client 74 of DSC 1 is converted into communication data of the TCP standard by the TCP driver 72 of DSC 1 and is also converted into communication data of the IP standard by the IP driver 71. The wireless communication circuit 13 of DSC 1 sends the communication data of this IP standard to the wireless network 3. The destination of the communication data of this IP standard is the IP address of the wireless server 2.

The wireless communication circuit 44 of the wireless server 2 connected to the wireless network 3 receives these communication data. In the communication data received by the wireless communication circuit 44, the IP address of the destination of these communication data is the self IP address. Accordingly, the communication data are reversely converted into the communication data of the TCP standard by the IP driver 61 of the wireless server 2, and are also reversely converted into the connection request by the TCP driver 62. The connection request generated by the reverse conversion is delivered from the TCP driver 62 to the copy server 64. Thus, the connection request is transmitted from the copy client 74 to the copy server 64.

The copy server 64 interprets the contents of this reversely converted connection request (step S3). Thus, the copy server 64 recognizes that DSC 1 corresponding to the automatic storage is connected.

The copy server 64 then generates a connection response described in the XML format and showing that the automatic storage of the same system as DSC 1 can be executed. The connection response generated by the copy server 64 of the wireless server 2 is converted into communication data of the TCP standard by the TCP driver 62 of the wireless server 2 and is also converted into communication data of the IP standard by the IP driver 61. The communication data are then transmitted from the wireless communication circuit 44 of the wireless server 2 to the wireless communication circuit 13 of DSC 1 through the wireless network 3. The communication data are reversely converted into communication data of the TCP standard by the IP driver 71 of DSC 1 and are also reversely converted into the connection request by the TCP driver 72. The connection response generated by the reverse conversion is delivered from the TCP driver 72 of DSC 1 to the copy client 74. Thus, the connection response is transmitted from the copy server 64 to the copy client 74 (step S4). Further, the copy client 74 interprets the contents of this reversely converted connection response and recognizes connection to the wireless server 2 able to execute the automatic storage of the same system as the self system (step S5).

When the connection processing is completed, the copy client 74 of DSC 1 starts function information acquisition processing. Concretely, for example, the copy client 74 of DSC 1 generates a get function request described in the XML format and transmits this get function request to the copy server 64 of the wireless server 2 (step S6). The copy server 64 interprets the contents of the get function request (step S7) and generates a get function response including information relating to self storage ability, etc.

For example, there are version information able to be coped by the copy server 64, a vendor name, vendor proper information, a device name of the wireless server 2, a type number, a serial number, etc. as the information relating to the self storage ability, etc. For example, there are also memory capacity of the memory device 46, vacant memory capacity, the kind of a filing system of the memory device 46, etc. as the information relating to the self storage ability, etc.

The copy server 64 of the wireless server 2 transmits this get function response to the copy client 74 of DSC 1 (step S8). The copy client 74 of DSC 1 interprets the information relating to the storage ability of the wireless server 2, etc. and included in this get function response (step S9).

When such function information acquisition processing is completed, the copy client 74 of DSC 1 subsequently automatically generates a store request (storage instructions) for storing an image data file 31 stored to the removable memory 20 to the wireless server 2 on the basis of this interpreted storage ability of the wireless server 2 (step S10). Concretely, the copy client 74 refers to the direct storage log data file 32 and generates the store request for storing all the image data files 31 which have not been automatically stored in the removable memory 20.

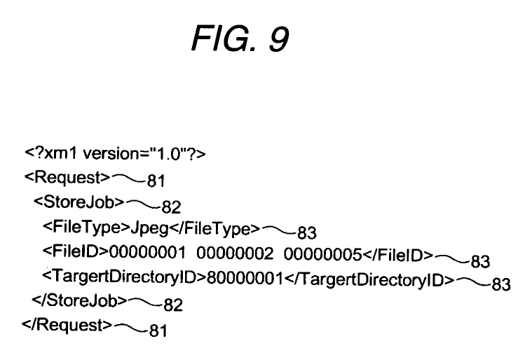

FIG. 9 is a view showing one example of the store request generated by the copy client 74. This store request is a request described in the XML format and is treated as one text data file. A pair of tags 82 showing that this request is a request with respect to a copy job (storage processing) are described between a pair of tags 81 showing the request. Further, text data showing the contents of the storage instructions are described in a state nipped in a pair of tags 83 showing respective attributes between the pair of tags 82 showing the copy job.

The store request of FIG. 9 is an example when three image data files 31 of the JPEG format having file IDs (an identification number corresponding to a file name as a pair) of “00000001”, “00000002” and “00000005” are stored to the removable memory 20. Further, a directory of the memory device 46 as a storing destination is designated as “80000001” in the store request of FIG. 9. In the store request of FIG. 9, a file automatically stored by the file ID of the image data file 31 is designated. However, for example, when the directory is constructed in the removable memory 20, the files within this directory may be also collectively designated by designating this directory.

The copy client 74 of DSC 1 transmits this store request to the copy server 64 of the wireless server 2 (step S11). The copy server 64 of the wireless server 2 interprets the contents of the storage instructions of this store request (step S12). The copy server 64 then gives instructions of acquisition of the image data file 31 required in this storage to the storage client 65 (step S13). The storage client 65 generates a get image file request for obtaining the image data file 31 from DSC 1 with respect to the image data file designated in the store request (Step S14), and transmits this get image file request to the storage server 75 of DSC 1 (step S15). The storage server 75 of DSC 1 gives instructions of transmission of the image data file 31 required in the get image file request to the storage device 76 (step S16). The storage device 76 of DSC 1 transmits the image data file 31 instructed in the storage server 75 to the wireless server 2 (step S17). This image data file is once stored to the RAM 47 of the wireless server 2. In the case of the store request of FIG. 9, three image data files 31 are stored to the RAM 47 of the wireless server 2. Transfer processing of this image data file is actually executed by transmitting and receiving communication data between the file transfer section 73 of DSC 1 and the file transfer section 63 of the wireless server 2.

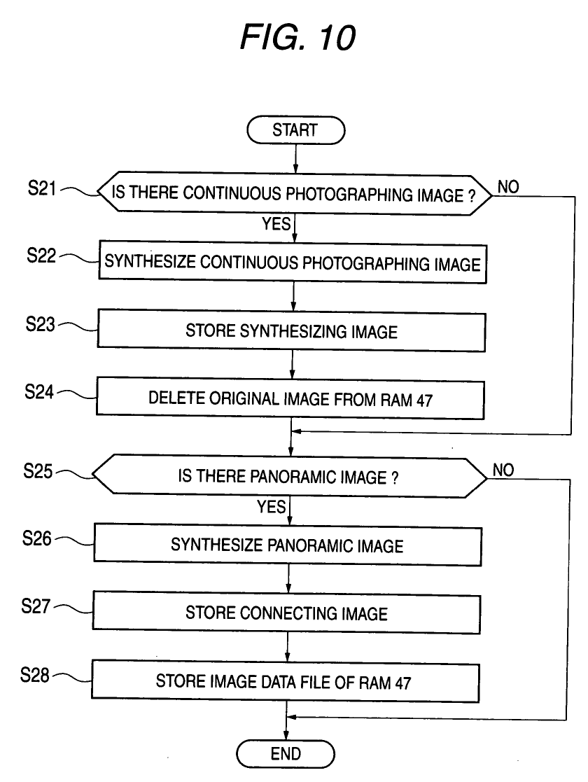

When the plural image data files 31 designated by the store request are obtained by the RAM 47, the copy server 64 of the wireless server 2 gives instructions of the storage processing to the storage processing section 66 (step S18). The storage processing section 66 starts processing for storing the image data file 31 stored to the RAM 47 to the memory device 46 (step S19). FIG. 10 is a flow chart showing one example of the storage processing of the storage processing section 66.

The storage processing section 66 first examines whether or not plural image data files storing a continuous photographing image exist among the plural image data files stored to the RAM 47 (step S21). Concretely, for example, the storage processing section 66 examines whether the file name of the image data file in the RAM 47 shows image pickup in the continuous photographing mode or not, and whether data showing the image pickup in the continuous photographing mode are included in the image data file as attribute information or not.

When the plural image data files picked up in the continuous photographing mode are included among the plural image data files stored to the RAM 47, the storage processing section 66 gives instructions of synthesis of these plural image data files to the continuous photographing synthesizing section 67 (step S22). The continuous photographing synthesizing section 67 generates a displayed dynamic image according to a photographing order of the images of the designated plural image data files 31, and stores the image data file of this generated dynamic image to the RAM 47 (step S23).

When the image data file of the dynamic image is stored to the RAM 47, the storage processing section 66 deletes the image data file of a static image used in the dynamic image from the RAM 47 (step S24).

Subsequently, the storage processing section 66 examines whether or not plural image data files each storing one portion of a panoramic image exist within the plural image data files stored to the RAM 47 (step S25). Concretely, for example, the storage processing section 66 examines whether or not the file name of the image data file in the RAM 47 shows the image pickup in the panoramic mode, and whether or not data showing the image pickup in the panoramic mode are included in the image data file as attribute information.

When the plural image data files picked up in the panoramic mode are included within the plural image data files stored to the RAM 47, the storage processing section 66 gives instructions of synthesis of these plural image data files to the panoramic synthesizing section 68 (step S26). The panoramic synthesizing section 68 generates a panoramic image obtained by synthesizing the images of the designated plural image data files, and stores the image data file storing this panoramic image to the RAM 47 (step S27).

When the image data file of a connecting image is stored to the RAM 47, the storage processing section 66 deletes the image data file 31 of a static image used in this connecting image from the RAM 47 (step S28).

When the generation processing of the image data file of the dynamic image and the generation processing of the image data file of the panoramic image are completed, the storage processing section 66 outputs the image data file after synthesis stored to the RAM 47 and the remaining image data files to the memory device 46 through the I/O port 43. The memory device 46 stores this image data file (step S29). In this storage, the storage processing section 66 may classify the image data file e.g., every image pickup date, defocusing image, panoramic image, continuous photographing image, person image and other images and may also store the image data file to the memory device 46. Further, the file name of the image data file may be also renewed so as to be different every kind of the image.

Thus, the image picked up in the continuous photographing mode in DSC 1 is automatically edited to the dynamic image and is stored to the memory device 46 of the wireless server 2. Further, the image picked up in the panoramic mode in DSC 1 is automatically connected and edited and is stored to the memory device 46 of the wireless server 2. Further, the image data file 31 of images picked up except for these modes is automatically stored to the memory device 46 of the wireless server 2 as it is.

It is returned to FIG. 8 and a print client transmits the generated store request to a print server (step S10). Thereafter, the file name or the file ID of the image data file 31 instructed so as to be stored in this store request is added to the direct storage log data file 32 (step S20). Thus, no automatic storage of the image data file 31 instructed so as to be stored in the automatic direct storage of this time is instructed in the automatic direct storage of the next time. Namely, only the image data file 31 added to the removable memory 20 after the storage of this time is stored in the automatic direct storage of the next time.

As mentioned above, in this embodiment mode, when the wireless server 2 and DSC 1 attain a connectable state, the wireless server 2 and DSC 1 are automatically connected and storage is automatically started. Accordingly, it is not necessary for a user to perform an operation for the storage to DSC 1 and the wireless server 2.

Further, in this embodiment mode, the store request for storing all the image data files 31 which have not been automatically stored, is generated on the basis of the direct storage log data file 32. Therefore, no image data file already stored to the wireless server 2 is instructed so as to be stored in the store request. As its result, there is no case in which the same image data file 31 of DSC 1 is stored to the wireless server 2 plural times.

Further, in this embodiment mode, the wireless server 2 generates the dynamic image from plural images picked up in the continuous photographing mode, and stores the image data file of this dynamic image to the memory device 46. The wireless server 2 also generates an image obtained by connecting plural images picked up in the panoramic mode, and stores the image data file of this connecting image to the memory device 46.

As its result, no user performs a complicated operation for storage and synthesis every time the image data file 31 arranged in DSC 1 is stored to the wireless server 2.

The above embodiment mode is an example of a preferred embodiment mode of the present invention. However, the present invention is not limited to this example, but can be variously modified and changed.

For example, in the above embodiment mode, DSC 1 and the wireless server 2 automatically perform the storage processing of the image data file 31 when DSC 1 and the wireless server 2 detect their connection. In addition to this, for example, if DSC 1 and the wireless server 2 detect their connection, DSC 1 and the wireless server 2 inquire of the display device 18 of DSC 1 about yes or no of the automatic storage, and may also perform the storage processing of the image data file 31 on the basis of automatic storage instructions inputted from the input device 19 in accordance with this inquiry.

In the above embodiment mode, the copy client 74 of DSC 1 judges completion of the connection processing with the wireless server 2, and automatically starts the storage on the basis of this judgment. However, the copy server 64 of the wireless server 2 may judge the connection completion with DSC 1 and may request the starting of the storage from DSC 1 and DSC 1 may also start the automatic storage in accordance with this request.

In the above embodiment mode, when the connection processing with the wireless server 2 using the communication means of a lower order protocol such as the file transfer section 73, etc. is completed, the copy client 74 of DSC 1 starts the automatic storage processing sequence. In this case, a time point for completing the connection processing with the wireless server 2 may be also set to a time point for completing the connection processing or the function information acquisition processing by the copy client 74.

In the above embodiment mode, the direct storage log data are stored to DSC 1 and the copy client 74 of DSC 1 generates the store request for giving the instructions of storage of the image data file 31 not included in this log. In addition to this, for example, the direct storage log data may be stored to the wireless server 2 and the store request for storing all the image data files 31 stored to the removable memory 20 may be transmitted to the copy client 74. Further, the copy server 64 of the wireless server 2 may perform the storage processing to the memory device 46 except for the image data file 31 included in the direct storage log data.

In the above embodiment mode, the direct storage log data file 32 is arranged separately from the image data file 31, and the log (storage hysteresis) of the direct storage is recorded to this direct storage log data file 32. In addition to this, for example, the log (storage hysteresis) of the direct storage may be also recorded to one portion of the image data file 31 as a printed flag.

In the above embodiment mode, DSC 1 is connected to the wireless server 2 through the wireless network 3. In addition to this, for example, DSC 1 may be also connected to a recording server able to automatically store the image data file through a wired network using a cable.

In the above embodiment mode, the continuous photographing synthesizing section 67 stores the image data file of the synthesized continuous photographing image to the RAM 47, and the storage processing section 66 stores this image data file to the memory device 46 together with other image data files. In addition to this, for example, the continuous photographing synthesizing section 67 may also directly store the image data file of the synthesized continuous photographing image to the memory device 46. Similarly, the panoramic synthesizing section 68 may directly store the image data file of the synthesized panoramic image to the memory device 46.

In the above embodiment mode, the image data file of the image synthesized by the continuous photographing synthesizing section 67, etc. is deleted from the RAM 47 by the storage processing section 66, and is not stored to the memory device 46 as its result. In addition to this, for example, the image data file as a source of the image data file of the synthesized image may be also stored to the memory device 46 together with this image data file of the synthesized image.

In the above embodiment mode, the storage processing section 66 executes the storage processing to the memory device 46 after the storage processing section 66 performs the continuous photographing synthesis processing and the panoramic synthesis processing. In addition to this, for example, after the storage processing to the memory device 46 is performed, the continuous photographing synthesis processing and the panoramic synthesis processing may be also performed with respect to the image data file stored to this memory device 46.

In the above embodiment mode, the mode of the image storing device is set to the server device. However, instead of this, modes such as a personal computer, a display device having a memory medium, a printer, etc. may be also set.

Further, in the above embodiment mode, the mode of the image supply device is set to the digital still camera. However, instead of this, modes such as a portable telephone having a photographing function, PDA (Personal Digital Assistants), a personal computer, etc. may be also set.

The image storing device, the image storing method and the automatic storing system in the present invention can be utilized to automatically accumulate the image picked up by the digital still camera to the wireless server, etc.

1. An image storing device comprising:
communication means;
acquisition means for immediately obtaining an image data file from an image supply device through said communication means after it is possible to communicate with said image supply device for transmitting said image data file;
dynamic image generating means for generating the image data file of a dynamic image from the image data file of plural static images using continuous photographing and included within said obtained image data file; and
memory means for storing said generated image data file of the dynamic image.

2. An image storing device comprising:
communication means;
acquisition means for immediately obtaining an image data file from an image supply device through said communication means after it is possible to communicate with said image supply device for transmitting said image data file;
panoramic generating means for generating the image data file of a panoramic image by synthesizing plural image data files including images each constituting one portion of the panoramic image among said obtained image data file; and
memory means for storing said generated image data file of the panoramic image.

3. An image storing method comprising:
a step for immediately transmitting an image data file from an image supply device to an image storing device after the image supply device for transmitting the image data file and the image storing device for storing the image data file can be communicated;
a step for generating the image data file of a dynamic image from the image data file of plural static images using continuous photographing and included within the image data file by said image storing device; and
a step for storing said generated image data file of the dynamic image to memory means of said image storing device.

4. An image storing method comprising:
a step for immediately transmitting an image data file from an image supply device to an image storing device after the image supply device for transmitting the image data file and the image storing device for storing the image data file can be communicated;
a step for generating the image data file of a panoramic image by synthesizing plural image data files including images each constituting one portion of the panoramic image among the image data files by said image storing device; and
a step for storing said generated image data file of the panoramic image to memory means of said image storing device.

5. An automatic storing system comprising:
the image storing device according to claim 1 or 2; and
the image supply device which has another communication means connected to said communication means of said image storing device and immediately starts storage processing of the image data file to said image storing device when this another communication means can communicate with said image storing device.
